(19) United States
(12) Patent Application Publication
(10) Pub. No.: US 2025/0258696 A1
(43) Pub. Date: Aug. 14, 2025

(54) Hardware Queue Manager Serving Multiple Processor Cores

(71) Applicant: TEXAS INSTRUMENTS INCORPORATED, Dallas, TX (US)

(72) Inventor: Joseph Aronson, Dallas, TX (US)

(21) Appl. No.: 18/931,046

(22) Filed: Oct. 30, 2024

Related U.S. Application Data
(60) Provisional application No. 63/552,225, filed on Feb. 12, 2024.

(51) Int. Cl. G06F 9/46

(52) U.S. Cl. CPC G06F 9/467

(57) ABSTRACT

A hardware-based queue manager is implemented in a network accelerator. The queue manager may receive input from a processor core into a set of registers designated for that processor core. Other sets of registers may be designated for other processor cores. The queue manager reads the input in the set of registers, which triggers the queue manager to begin a transaction, such as reading or writing to a queue data structure in a data memory. The queue data structure may handle multiple sizes of queue data structures.

### CROSS-REFERENCE TO RELATED APPLICATIONS

The present application claims the benefit of U.S. Provisional Patent Application 63/552,225, filed Feb. 12, 2024, the disclosure of which is hereby incorporated by reference in its entirety.

### TECHNICAL FIELD

The present disclosure relates generally to a hardware queue manager and, more specifically, to a hardware queue manager configured to support multiple processor cores.

### BACKGROUND

In digital systems, queues are data structures and may be used to store data, pass data to other hardware elements or across clock domains, or backlog work to be done by software. Managing these queues is often costly for software as it may require many instructions and excessive time to create and remove entries, keep entries current, and perform other queue management tasks, taking away bandwidth from other tasks.

### SUMMARY

In an arrangement, a method includes: receiving first input from a first processor core, wherein the first input is written by the first processor core to a first set of registers; receiving second input from a second processor core, wherein the second input is written by the second processor core to a second set of registers; arbitrating between the first set of registers and the second set of registers to access a buffer, including writing the first input from the first set of registers into the buffer and then subsequently writing the second input from the second set of registers into the buffer; and performing a first transaction according to the first input, wherein the first transaction is performed on a data memory, the first transaction including writing first feedback data to the first set of registers.

In an arrangement, a network accelerator includes: a first plurality of processor cores, including a first processor core and a second processor core; a queue manager having a first set of registers corresponding to an identification of the first processor core and a second set of registers corresponding to an identification of the second processor core; and a data memory configured to store a plurality of queue data structures; wherein the queue manager is configured to: receive input data from the first processor core and the second processor core into the first set of registers and the second set of registers, respectively; write the input data from the first set of registers and the second set of registers into a buffer, including arbitrating between the first set of registers and the second set of registers; read the contents from the buffer into a state machine; and perform operations on the plurality of queue data structures according to the state machine.

In an arrangement, hardware-based manager of a plurality of queue data structures includes: a first plurality of registers that is memory mapped to a first processor core; a second plurality of registers that is memory mapped to a second processor core; hardware logic configured to: arbitrate between the first plurality of registers and the second plurality of registers for writing from the first plurality of registers and the second plurality of registers to a first in first out (FIFO) buffer; and read contents from the FIFO buffer and perform operations of a state machine based on the contents, where the state machine is configured to perform push operations and pop operations on the plurality of queue data structures and to return feedback data to the first plurality of registers and to the second plurality of registers.

### BRIEF DESCRIPTION OF THE DRAWINGS

Having thus described the invention in general terms, reference will now be made to the accompanying drawings, wherein:

FIG. 1 is an illustration of an example queue manager, which is in communication with a data memory and is adapted according to some embodiments.

FIG. 2 is an illustration of an example header of a queue data structure, such as may be stored in a data memory, according to some embodiments.

FIG. 3 is an illustration of an example operation of a state machine, according to some embodiments.

FIG. 4 is an illustration of an example method, for managing queue data structures, according to some embodiments.

FIG. 5 is an illustration of an example network accelerator, according to some embodiments.

FIG. 6 is an illustration of an example system on-chip (SoC), which may include a network accelerator, such as the network accelerator of FIG. 5, according to some embodiments.

### DETAILED DESCRIPTION

The present disclosure provides a hardware-based manager for queue data structures. As noted above, managing queue data structures may be costly, and queue data structures may be managed by hardware or software managers.

Hardware is generally expected to be able to manage queue data structures more efficiently yet has limitations from balancing area cost and functionality. One example is that a hardware queue manager may support a limited number of queues with a limited number of elements per queue to keep area cost down. It could support more, but that would generally be expected to increase area. Another example is that a hardware manager may support one element size for design simplicity, but this may lead to inefficiencies if the element size is bigger than most uses/applications or limitations if not big enough. A third example is that a hardware manager may interface with a single processor core for simplicity in terms of data coherency and scope; however, this is not conducive to systems with multiple processor cores.

For hardware, an efficient design may depend on applications and requirements to meet the needs of the system while maintaining a low cost. More capable and feature-rich hardware may be used to meet the growing demands and constantly changing standards. This hardware may offload more work from software and handle more networking traffic. There are increasing requirements and use cases to connect devices over different networking protocols, which is part of that extra traffic.

In some examples, the hardware queue manager is virtualized so that it may support multiple element sizes, multiple processor cores, and ordered lists. The queue manager may support push back, pop front, peek operations, and/or other operations as appropriate.

The virtualization may allow processor cores to interface with the queue manager without contention (e.g., lock-free). This may improve performance as it may prevent blocking a first processor core due to being consumed by another processor core. Such virtualization may also provide access by different sized processor cores (e.g., data path width) via virtualized data registers. Thus, the virtualization may enable streamlined access by processor cores since the queue manager does not have to switch contexts or block processor cores.

The queue manager may include a memory interface to access queue data structures and perform operations on the queue data structures. This may allow the system to connect an appropriately sized memory for its queue needs. The queue manager may support multiple element sizes and quantities of elements in a queue data structure. This may provide flexibility for processor cores and applications and may help improve memory usage efficiency.

The queue manager may support ordered list types in addition to queue types. The element for ordered lists may include a key/value pair; it orders by key, either in increasing or decreasing direction. Push operations may insert a new element by linearly walking the list and comparing keys then shifting the remaining elements to write the new element in its desired place by key. Pop operations and peek operations may occur in constant time.

Accordingly, some examples provide lock-free access to any queue data structure in accessible memory of various queue types/element sizes/number of elements. Some such examples also support access by differently sized processor cores. This may be advantageous because it may support the flexibility of being implemented in different systems, support many use cases, and provides quick, lock-free access to processor cores.

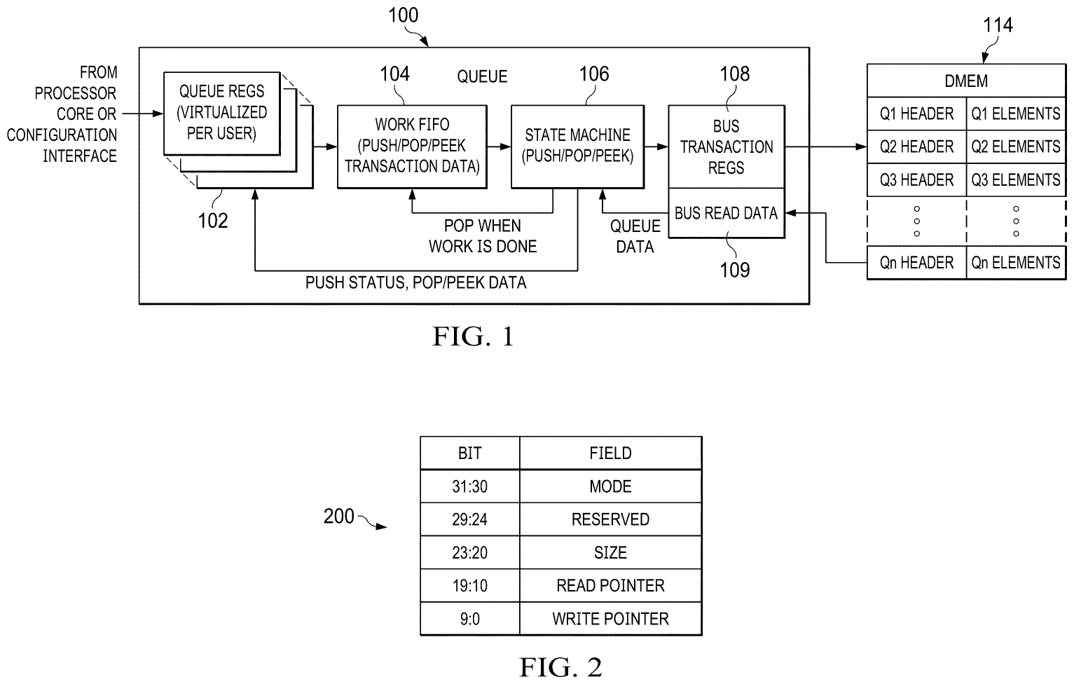

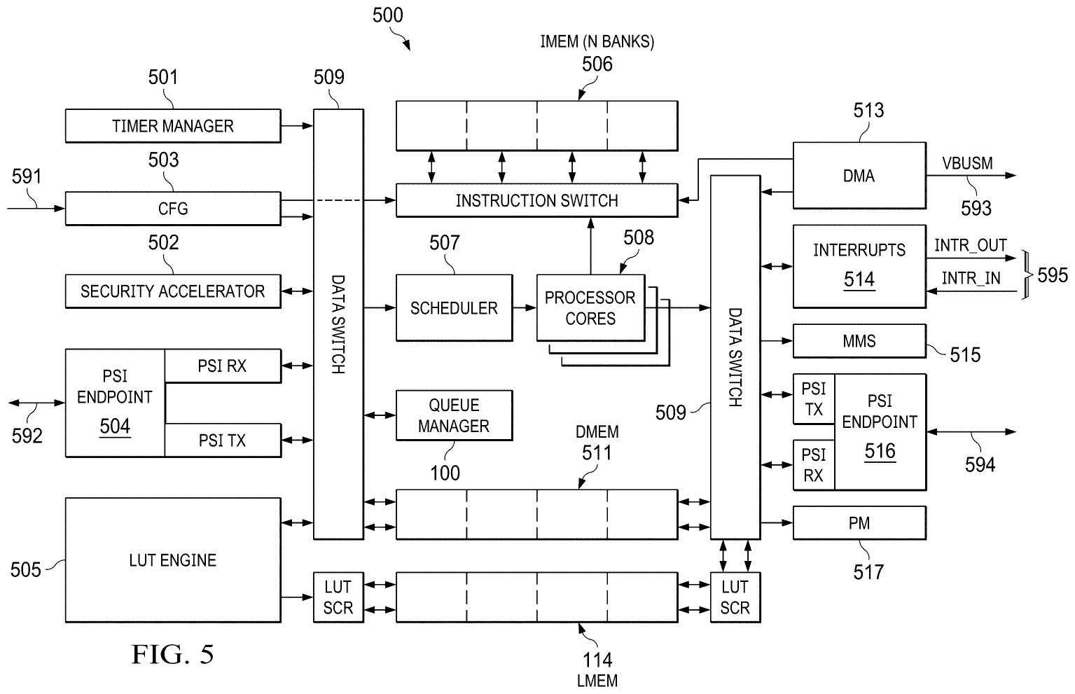

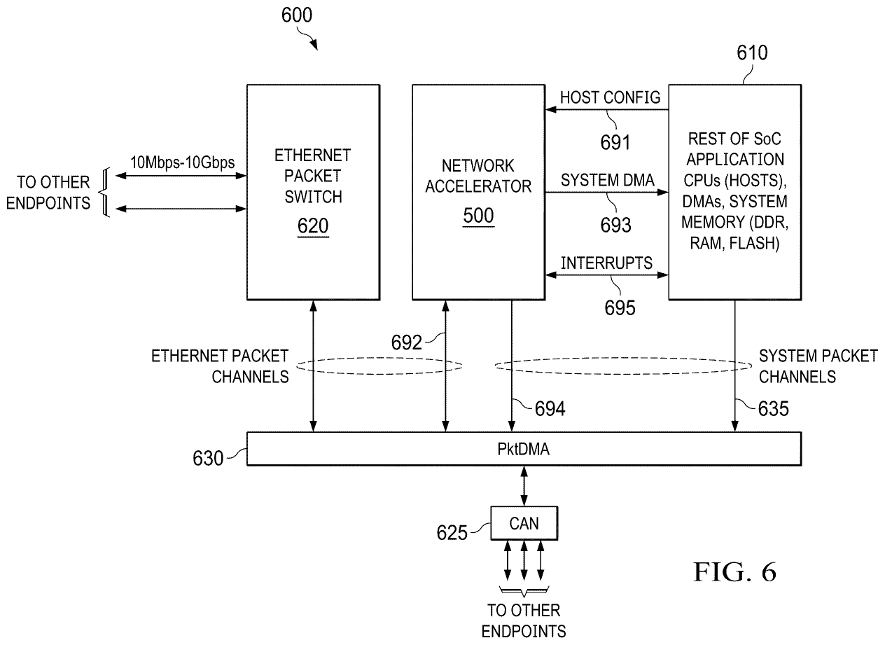

FIG. 1 is an illustration of example queue manager 100, which is in communication with a data memory 114 and is adapted according to some embodiments. Queue manager 100 may be implemented using fixed-purpose (i.e., hardcoded) circuitry, programmable circuitry, or a combination thereof and may be incorporated into another circuit, such as in a network accelerator, which itself is implemented within a system on-chip (SoC). An example of a network accelerator includes network accelerator 500 of FIG. 5, and an example SoC includes SoC 600 of FIG. 6.

Queue manager 100 may manage writing to and reading from the queue data elements in data memory 114. In the present example, the data memory 114 includes queue data elements 1-n, where n may be any appropriate positive integer. Each of the queue data structures (labeled Q1, Q2, etc.) includes a header and elements. An example of a header is described in more detail in FIG. 2, and, in short, a header may include data describing a queue data structure. Each queue data structure also includes a corresponding component labeled “Elements,” which may include any appropriate data. For instance, the elements for a queue data structure may include pointers to fragments to be formed into a packet in one example. Further in this example, the elements in a given packet may be stored to a buffer, and that buffer may be a first in first out (FIFO) buffer or other buffer that allows data to be shifted in and read out. For instance, a pop operation may remove data from a “top” of a queue data structure, where the remaining data then moves up to the top. Similarly, a push operation may write data to a “bottom” of the queue data structure.

In one example use case, there may be a multitude of fragments to be assembled into packets. A processor core (e.g. a processor core 508 of FIG. 5 or a processor core in item 610 of FIG. 6) may offload tracking the fragments to the network accelerator (e.g., network accelerator 500 of FIG. 5). For instance, the processor core may issue commands to the queue manager 100 to push pointers of the fragments into a queue data structure that is stored in data memory 114. The processor core may then assemble the packets from the fragments by popping the pointers from the queue until there are no more pointers left to pop. The processor core may pop the pointers by issuing commands causing the queue manager 100 to read those pointers from queue data structures in the data memory 114.

In another use case example, the network accelerator (e.g., network accelerator 500 of FIG. 5) may receive multiple packets. The processor core (e.g., a processor core 508 of FIG. 5) may use the queue manager 100 to push pointers to a queue data structure, where those pointers indicate addresses in the data memory 114 of packets. When the processor core is ready to process the packets, it may read out (“pop”) the pointers using the queue manager 100.

Of note in this example, the data memory 114 may store not only the queue data structures, but it may also store other data, such as packets. The queue data structures may include pointers that indicate addresses of packets (or fragments of packets) in the data memory 114.

The queue manager 100 includes queue registers 102, which are virtualized per processor core. For instance, a first set of the registers in registers 102 may include memory mapped registers (MMRs) that are mapped to an address space associated with a first processor core, a second set of the registers in registers 102 may include MMRs that are mapped to an address space associated with a second processor core, and on and on for as many processor cores as may access the queue manager 100. In this manner, each processor core has access to one and only one set of registers within the registers 102, and each of the sets of registers may be the same. For instance, if there are M processor cores that may access the queue manager 100, then there may be M sets of registers in the registers 102, where M is any appropriate integer larger than one.

Examples of processor cores that may access the queue registers 102 include the processor cores 508 of FIG. 5 and processor cores that may exist in the SOC at item 610.

In one example, one set of registers, associated with one processor core, may include the following individual registers:
STATUS.VALID: valid status of the processor core's last completed push access. This register may be read by a processor core to determine whether a requested push was determined to be valid. For instance, a push to a full queue structure may result in the queue manager 100 writing a value (e.g., 0) to indicate that the attempted push operation is invalid. However, the queue manager 100 may write a different value (e.g., 1) to indicate that an attempted push operation is valid.
STATUS.DONE: completion status of the processor core's last push access. For instance, once a push operation is complete, the queue manager 100 may write a value (e.g., 1) to indicate that the push operation is complete. Before the push operation is complete, the value may be a 0.
PTR: address of queue to access. The processor core may write to this register to indicate an address within data memory 114 at which the queue data structures located. The push, pop, peek operation may then be performed by the queue manager 100 on that queue data structure.
PUSH_POP32: 32-bit element to push to or pop from 32-bit queue. In the case of a 32-bit push, the processor core may write data to be pushed in this register; the queue manager 100 may write this data from this register to an identified queue data structure. In the case of a 32-bit pop, the queue manager 100 may write the data, which was popped from the identified queue data structure, to this register. The processor core may then read the popped data.
PUSH_POP64_LO: lower 32 bits of 64-bit element to push to or pop from 64-bit/ordered queue (32-bit value if ordered). In this example, push operations and pop operations are performed in 32-bit portions—a lower 32 bits and an upper 32 bits. So in an example using 64-bit operations, the operation is split into two operations that are directed at the lower 32 bits and the upper 32 bits. Data may be read to or written from this register the same as with PUSH_POP32.
PUSH_POP64_HI: upper 32 bits of 64-bit element to push to or pop from 64-bit/ordered queue (32-bit key if ordered). In this example, push operations and pop operations are performed in 32-bit portions—a lower 32 bits and an upper 32 bits. So in an example using 64-bit operations, the operation is split into two operations that are directed at the lower 32 bits and the upper 32 bits. Data may be read to or written from this register the same as with PUSH_POP32.
POP_PEEK64_HI_SAVE: upper 32 bits of last 64-bit or ordered queue pop/peek access.
PEEKn_IDX: peek at index ‘n’ from queue. A peek operation in this example is a read operation that is non-destructive. In other words, the data is not removed from the queue data structure when it is read. This register stores a pointer to an address in data memory 114 at which the peeked data has been written. A peek operation may be performed at any location in the queue and does not limited to a location indicated by the read pointer.

Each processor core may be associated with a similar set of registers within registers 102. A given processor may trigger an access request by writing to its corresponding set of registers within registers 102. For instance, to trigger a push operation, a processor core may write to the PTR register and the PUSH_POP32 register (or the PUSH_POP64 registers in the case of a 64-bit operation). To trigger a pop operation, a processor core may write to the PTR register and then read from a PUSH_POP or POP_PEEK register. To trigger a peek operation, a processor core may write the PTR register and then read from the PEEK[n]_IDX register.

To be more specific, for a 32-bit processor core to push to a 64-bit queue, it may write to both PUSH_POP64_LO and PUSH_POP64_HI registers. For a 32-bit processor core to pop from a 64-bit queue, it may read from both PUSH_POP64_LO and POP_PEEK64_HI_SAVE registers. In an ordered queue case, the processor core may skip reading POP_PEEK64_HI_SAVE, which returns the key, if not needed. For a 32-bit processor core to peek from a 64-bit queue, it may read from both PEEK[n]_IDX and POP_PEEK64_HI_SAVE registers. In an ordered queue case, the processor core may skip reading POP_PEEK64_HI_SAVE, which returns the key, if not needed.

Of course, these are just examples, and various embodiments may implement registers for a processor core as appropriate.

There are multiple sets of registers in the registers 102, one for each processor core, as mentioned above. However, first in first out (FIFO) buffer 104 has a single input. Therefore, the queue manager 100 may arbitrate between the different sets of registers within registers 102 to read out data from a given set of registers and write that data to the FIFO 104. The FIFO 104 may act as a work FIFO by serializing access transactions from the processing cores, thereby allowing one transaction at a time to the queue data structures in the data memory 114. Such an arrangement may prevent multiple processor cores from attempting to access a single piece of information at the same time. In one example, the different sets of registers within registers 102 may be arbitrated using a round robin technique, though the scope of implementations may use any appropriate ordering technique for reading one set of registers at a time.

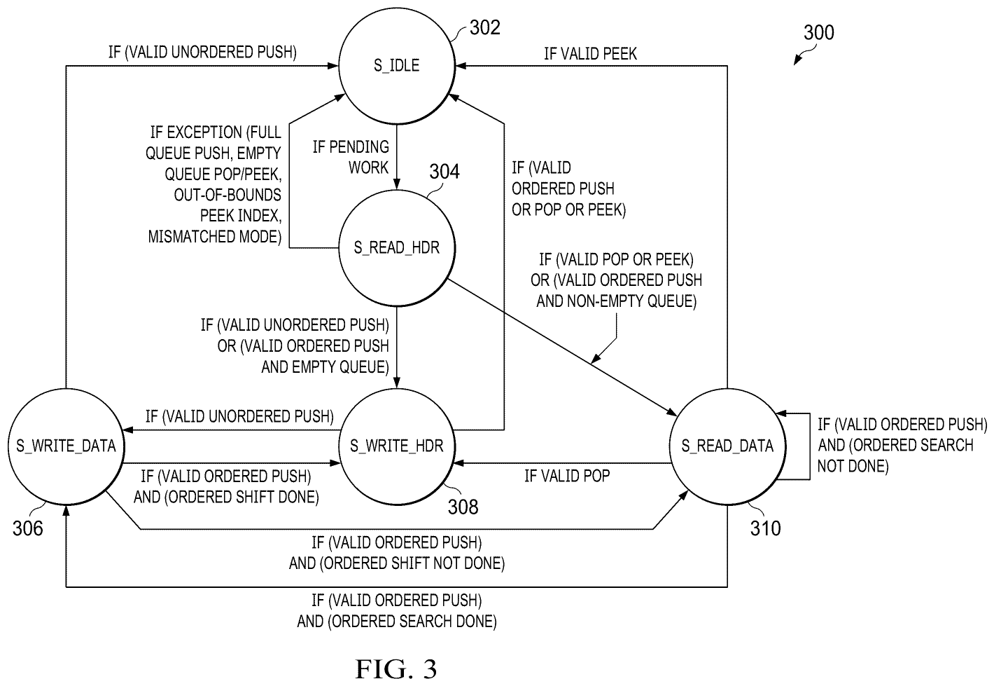

The state machine 106 is described in more detail with respect to FIG. 3. In short, the state machine 106 may carry out a push operation, pop operation, or peek operation (if valid) based on the data in the FIFO 104. Specifically, the state machine 106 is configured to access a queue data structure from the data memory 114, according to the PTR register, via the bus transaction registers 108 and bus read data interface 109. The state machine 106 may perform a push operation, a pop operation, or a peek operation on a queue data structure in the data memory 114 and then return feedback data to the queue registers 102. Feedback data may include push status data and pop or peek data as appropriate.

The state machine 106 may also, once having completed a transaction from the FIFO 104, pop the data for that transaction from the work FIFO 104, which causes data for the next transaction to move to the top of the work FIFO 104. Similarly, the queue manager 100 may read out the next set of data from registers 102 and write that data to the bottom of the work FIFO 104. The process may repeat over and over for as long as there are transactions waiting in the queue registers 102.

Although not specifically shown in FIG. 1, space within data memory 114 may be allocated to a queue data structure in any appropriate manner. For instance, in some embodiments, a processor core (e.g., a processor core 508 of FIG. 5 or a processor core at item 610 of FIG. 6) may request a memory manager (e.g., memory manager 515 of FIG. 5) to allocate data in memory 114 for a queue data structure. However, other embodiments may use a different technique for allocation, and any appropriate allocation technique may be used.

FIG. 2 is an illustration of an example header 200 of a queue data structure, such as may be stored in data memory 114, according to some embodiments. For instance, example queue data structure 200 shows how a header, such as Q1 Header of FIG. 1, may be formatted.

A field Write Pointer may be used to indicate where data may be written within the elements (e.g., Q1 Elements) of a queue data structure. As noted above, the queue data structure may include writing to a bottom of a queue data structure and reading from the top of the queue data structure. The Write Pointer may point to an available space at the bottom of the queue data structure for writing new data.

A field Read Pointer may be used to indicate where data may be read from the elements (e.g., Q1 Elements) of a queue data structure. As noted above, the queue data structure may include reading from a top of the queue data structure. The Read Pointer may point to the top of the data structure.

The Size field may indicate a quantity of the elements in a queue data structure, where each element may be an eight-bit byte or other appropriate size. In some examples, the sizes may be in powers of two, such that sizes may refer to 4 elements, 8 elements, 16 elements, and so on. The Size field, together with the Read Pointer and the Write Pointer, indicate whether the respective queue of elements is full, empty, or partly full.

The Mode field may refer to whether the elements are written as 32-bit values, 64-bit values or are ordered elements. For instance, a 32-bit mode may be indicated by a 0, a 64 bit mode may be indicated by 1, and an ordered mode may be indicated by 2 for up and 3 for down. In one example, queue elements may be implemented as 32-bit key/value pairs and may be ordered by increasing (up) or decreasing (down) keys.

A given queue data structure may include elements that are either ordered or un-ordered. Ordered elements may include keys, where the keys either increase in value or decrease in value and indicate an order of a particular element. In one example, multiple CAN IDs may be used as keys and arranged in order, where the numerical order corresponds to a priority order. In such an example, a packet pointer may point to the packet and to a particular CAN ID in the packet. By contrast, a backlog of work may be stored in a queue in an order corresponding to time of reception, though the items of work in the queue may not be in any particular numerical order.

FIG. 3 is an illustration of an example operation 300 of a state machine, such as state machine 106 of FIG. 1, according to some embodiments. The queue manager 100 may be implemented using hardware logic, and state machine 106 may be implemented according to that hardware logic, such as by implementing Boolean logic gates that receive binary data from the FIFO 104 and then perform read operations, write operations, and pop operations based on that binary data.

State 302 is an idle state, and it refers to a state of the state machine 106 between completion of a first operation and start of the subsequent operation. The “if pending work” query refers to determining whether the FIFO 104 includes next data to indicate an operation.

Once the state machine 106 receives data from the FIFO 104, referring to a push or pop or peek operation, the state machine 106 moves to state 304 to read the header of the queue data structure referenced in the PTR register. The header, such as described above with respect to FIG. 2, may indicate whether the elements of the queue data structure are empty, full, or partly full. An attempt to pop or peek from an empty queue data structure or push to a full data structure may result in an error (invalid) and a return to the idle state 302; otherwise, the operation may be valid so that the state machine 106 moves to either state 308 or state 310.

If the operation is a valid pop or peek or is a valid ordered push with a nonempty queue, then the state machine progresses to state 310, where it reads the data. In the case of a pop operation, the state machine 106 reads the data from the top of the queue data structure then progresses to state 308 to write a new read pointer to the header and then returns to the idle state 302. In the case of a peek operation, the state machine 106 reads the data from the top of the queue and does not write a new read pointer because in this example a peek operation is non-destructive. The state machine 106 then returns to the idle state 302.

In the case of an ordered push with a non-empty queue, the state machine progresses to state 310 to read the keys associated with the elements in the queue data structure to perform an ordered search. The state machine 106 reads the elements and compares the keys of the elements with a key of an element being written. Once the state machine 106 has found the correct index from the search, the state machine 106 may insert the new element and shift the remaining elements (read, save, then write) and update the header with the correct read and write indices. This is illustrated by progression from state 310 through states 306 and 308. Once the ordered push is complete, the state machine moves to the idle state 302.

In the case of an un-ordered push, the state machine 106 progresses to state 308, where it writes an adjusted write pointer to the header, and then the state machine 106 progresses to state 306, where it writes the data. The state machine 106 may then return to the idle state 302. An ordered push with an empty queue is performed similarly to an unordered push because there is no need to first read the keys.

In the examples above a read (pop or peek) operation may be performed from a top of a queue data structure; a write (push) operation may be performed from a bottom of a queue data structure. Each operation, whether push, peek, or pop, may be performed with respect to a single element in some instances. However, the scope of implementations may include push, peek, or pop operations toward multiple elements at a same time. Of course, the operation 300 of the state machine 106 is an example. Other embodiments may implement a different state machine or have a greater quantity or lesser quantity of states.

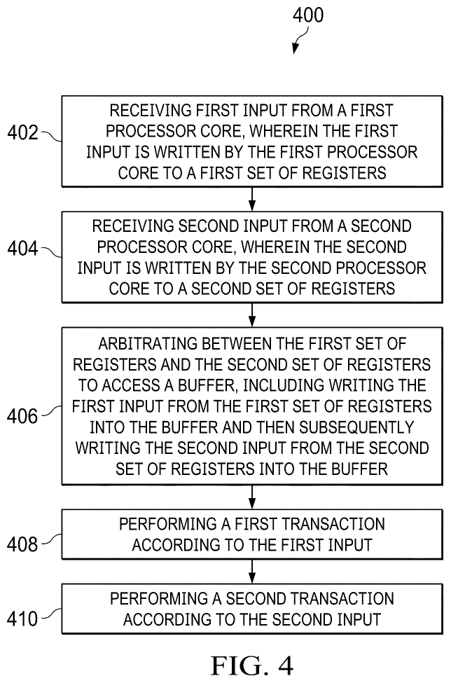

FIG. 4 is an illustration of an example method 400, for managing queue data structures, according to some embodiments. Method 400 may be performed by a queue manager, such as queue manager 100 of FIG. 1. In some implementations, the queue manager 100 may be implemented using hardware logic so that the actions described below may be performed using Boolean logic gates.

At action 402, the queue manager 100 receives input from a first processor core. In this example, the first input is written by the first processor core to a first set of registers. As an example, the registers 102 of FIG. 1 may be divided into a plurality of sets of registers, each set of registers being associated with a different processor core. In one example, each of the processor cores is associated with a processor core ID, and the queue manager 100 may include logic to cause a processor core to read from and write to a particular set of registers based on its processor core ID.

Further in this example, the set of registers written to by the first processor core may include MMRs, so that the processor may write the input to an address space native to that processor core.

In one example of action 402, the input may include a pointer to an address range of a queue data structure that is to be the object of a transaction. This may be true in the case of a read transaction (e.g., a pop operation or a peek operation) or a write transaction (e.g., a push operation). Furthermore, in the case of a write transaction, the input may further include writing to registers to cause that data to be pushed to a queue data structure. For example, the PUSH_POP registers described above may be configured to receive data from the processor core for a push operation. The PTR registers described above may be configured to receive data identifying a queue data structure.

At action 404, the queue manager 100 may receive second input from a second processor core. In this example, the second input may be written by the second processor core to a second set of registers. As described above, the registers such as registers 102 may be divided into a plurality of sets of registers with each set of registers corresponding to a different processor core. In this example, the second processor core may write to a different set of registers than the first processor core wrote to. Once again, the second set of registers may be MMRs, and they may be mapped to an address space native to the second processor core.

At action 406, the queue manager 100 arbitrates between the first set of registers and the second set of registers to access a buffer. For instance, the sets of registers in registers 102 of FIG. 1 feed into the FIFO 104 through a single input. In other words, the contents of the sets of registers are read out and then written to FIFO 104 set-by-set, one at a time. The arbitration of action 406 may include a round-robin technique, which goes from one set of registers to the next set of registers and on and on, returning to the first set of registers after the last set of registers, and repeating. Of course, the scope of implementations may include any kind of arbitration, including a priority-based arbitration if appropriate.

In this example, action 406 includes writing the first input from the first set of registers into the buffer and then subsequently writing the second input from the second set of registers into the buffer. In other words, the FIFO 104 creates a serialized order for transactions from the processor cores. An advantage of such embodiments may include that each piece of work is completed by the state machine 106 (or is returned as invalid) before a next piece of work gets to the state machine 106 from the FIFO 104.

Action 408 includes performing a first transaction according to the first input. Performing the transaction may include reading a portion of a header of a queue data structure targeted by the first transaction to determine a configuration of the queue data structure. For example, the header may specify an element size, whether the queue data structure is ordered, and, if so, whether the order is ascending or descending.

The transaction of action 408 may include a pop operation. A pop operation may include reading the header of the queue data structure to determine a read pointer, reading from the queue data structure according to the read pointer, popping read data from the queue data structure, and updating the read pointer based on reading from the queue data structure. In the case of a pop operation, action 408 may include writing feedback to the first set of registers. Such feedback may include the data read from the queue data structure.

In another example, the transaction of action 408 may include a push operation. The push operation may include reading the header of the queue data structure to determine a write pointer, writing to the queue data structure according to the write pointer, and updating the write pointer based on writing to the queue data structure. The push operation may include writing feedback to the first set of registers, including writing a valid status and/or a complete status to the first set of registers.

In another example, the transaction of action 408 may include a peek operation. The peek operation may include reading the header of the queue data structure to determine a read pointer, reading from the queue data structure according to the read pointer, and not updating the read pointer based on the peek operation because the peek operation is non-destructive. The peek operation may include writing an index of peek data (or the peek data itself) to the first set of registers.

In yet another example, the transaction of action 408 may include a push operation for an ordered queue data structure. The operation may include reading the header of the queue data structure to determine a write pointer, writing to the queue data structure according to the write pointer, including performing a linear key search within the ordered queue data structure and inserting write data within the ordered data structure according to the linear key search, and updating the write pointer or read pointer based on writing to the queue data structure. When inserting in ordered lists, the queue manager may update either the read pointer or write pointer based on insertion index: if in the first half of elements, shift front and update read pointer; if in the second half of elements, shift back and update write pointer In fact, the transaction of action 408 may include reading the header of the queue data structure to determine whether the queue data structure is an ordered queue data structure or not. The push operation may further include writing a valid status and/or a completion status to the first set of registers.

The scope of implementations may include performing any appropriate transaction as part of action 408.

Action 410 includes performing a second transaction according to the second input. Once the first transaction has been completed, the state machine may move to the second transaction for the second processor core. The second transaction may be the same as or similar to those example transactions given above with respect to action 408, though the feedback data may include writing to the second set of registers for the second processor core.

The scope of implementations is not limited to the series of actions 402-410. Rather, other embodiments may add, omit, rearrange, or modify one or more of the actions. In one example, further processor cores may write data to respective sets of registers, and those sets of registers may be arbitrated, resulting in further transactions. Additionally, the queue manager 100 may move from one transaction to the next over and over until either there are no more transactions or a power off or other stop.

FIG. 5 is an illustration of an example network accelerator 500, which may include a queue manager (e.g., queue manager 100 of FIG. 1), according to some embodiments. The example network accelerator 500 may be implemented within a system on-chip (SoC) such as example SoC 600 of FIG. 6.

Network accelerator 500 includes a plurality of processor cores 508, which may include any appropriate processor cores, whether general purpose or otherwise and having any sized instruction set. In one example, each of the processor cores 508 execute firmware to provide processing functionality for network accelerator 500. For instance, timer manager 501 may perform an action that includes transmitting a function indication and an argument to the scheduler 507 upon expiry of a timer. Scheduler 507 may then pass that function indication and argument to one of the processor cores 508. Processor cores 508 may fetch instructions from instruction memory 506 or receive instruction pointers from direct memory access (DMA) interface 513 via bus 593.

An application processor core (e.g., in 610) may offload network functions to the network accelerator 500 so that the application processor core does not have to perform those functions itself. Configuration interface 503 allows for an application processor core to communicate with any of the components of network accelerator 500. For instance, an application processor core may communicate via bus 591, and such communication may write to registers 102 and/or may cause an instruction to be transmitted to one of the processor cores 508.

Security accelerator 502 may perform security functions on behalf of the processor cores 508. For instance, some types of packets (e.g., ethernet packets) may be designated as un-trusted. In such an example, the processor cores 508 may cause such packets to be indicated as either secure or not secure by security accelerator 502 before further processing.

Packet switch interface (PSI) end points 504 and 516 may receive packets and transmit packets into and out of the network accelerator 500 via buses 592 and 594, respectively. Upon receiving a packet, a PSI endpoint 504, 516 may perform a read operation with memory manager (MMS) 515 to cause space to be allocated within the data memory 511. Once space in the data memory 511 is allocated, the PSI endpoint 504, 516 may then store that packet to the data memory 511 in the allocated address range.

Network accelerator 500 includes two PSI endpoints 504, 516 for increased bandwidth, where PSI endpoint 504 is dedicated for ethernet use, and PSI endpoint 516 is dedicated to other packet protocols. Nevertheless, various embodiments may be adapted for either more or fewer PSI endpoints as appropriate.

An application processor core may configure actions to be taken for particular packets in some examples by writing to lookup table entries in lookup table memory 512. When a packet is received and ready for processing, a processor core 508 may cause lookup engine 100 to perform a lookup operation within the lookup table entries in lookup table memory 114. A lookup operation may result in subsequent actions, such as events being sent to scheduler 507 by lookup engine 100, where such event may cause an action by a processor core 508.

Queue manager 100 may be used by the processor cores 508 to manage queues in some examples, as was described above.

The larger system in which network accelerator 500 is implemented (e.g., SoC 600) may transmit interrupts to the processor cores 508 via interrupt interface 514 and buses 595.

Priority manager 517 is implemented to prioritize some packets over other packets, based on configuration data from an application processor core. For instance, some packets may include data indicating a priority level, and the priority manager 517 may perform priority functions, such as enforcing an order of data memory allocation for packets based on priority levels of the packets.

The various components are communicatively coupled within network accelerator 500 by data switches 509.

FIG. 6 is an illustration of an example SoC 600, according to some embodiments. Network accelerator 500 may be implemented on the SoC 600, though the scope of implementations may include network accelerator 500 being implemented in any appropriate system for offload of network functions by any appropriate processor core.

SoC 600 may be implemented on a semiconductor die. The semiconductor die may be implemented within a semiconductor package by itself or with other semiconductor dies.

In the present example, ethernet packets may be received by the ethernet packet switch 620. Packets of other protocols, such as control area network (CAN), may be received by packet switch 625. However, the scope of implementations may include more packet switches or fewer packet switches to handle more or fewer communication protocols as appropriate.

Continuing with a packet receive operation, the packets from packet switches 620, 625 are then transmitted to packet direct memory access 630, which in this example, formats the various packets into one or more formats that are efficient for processing by network accelerator 500. Once the packet DMA 630 has formatted the packets, packet DMA 630 may transmit the packets to the network accelerator 500 via buses 592, 594. Packet direct memory access 630 may communicate with the rest of the SoC 610 through system packet channels 635.

As noted above, the network accelerator 500 may perform network functions on the packets, which allows network functions to be offloaded from the rest of the SoC 610. Examples of operations that the network accelerator 500 may perform include, but are not limited to, reformatting a packet from one protocol to another (e.g., ethernet to CAN or vice versa), dropping a packet, forwarding a packet to a different endpoint, sending payload data from a packet to a component of the rest of the SoC 610, and the like. For an outgoing packet, the network accelerator 500 may transmit such packet to the packet DMA 630 via one of buses 592, 594 to either ethernet packet switch 620 or packet switch 625. The network accelerator 500 may also transmit the payload data from the packet to the rest of the SoC 610 via bus 593.

The rest of the SoC 610 may be configured as appropriate. For instance, the rest of the SoC 610 may include one or more processor cores (e.g., application processor cores, digital signal processing cores, and the like) system memory, memory interfaces or accelerators, and the like.

The present disclosure is described with reference to the attached figures. The figures are not drawn to scale, and they are provided merely to illustrate the disclosure. Several aspects of the disclosure are described below with reference to example applications for illustration. It should be understood that numerous specific details, relationships, and methods are set forth to provide an understanding of the disclosure. The present disclosure is not limited by the illustrated ordering of acts or events, as some acts may occur in different orders and/or concurrently with other acts or events. Furthermore, not all illustrated acts or events are required to implement a methodology in accordance with the present disclosure.

Corresponding numerals and symbols in the different figures generally refer to corresponding parts, unless otherwise indicated. The figures are not necessarily drawn to scale. In the drawings, like reference numerals refer to like elements throughout, and the various features are not necessarily drawn to scale. In the following discussion and in the claims, the terms “including,” “includes,” “having,” “has,” “with,” or variants thereof are intended to be inclusive in a manner similar to the term “comprising,” and thus should be interpreted to mean “including, but not limited to . . . .” Also, the terms “coupled,” “couple,” and/or or “couples” is/are intended to include indirect or direct electrical or mechanical connection or combinations thereof. For example, if a first device couples to or is electrically coupled with a second device that connection may be through a direct electrical connection, or through an indirect electrical connection via one or more intervening devices and/or connections. Elements that are electrically connected with intervening wires or other conductors are considered to be coupled. Terms such as “top,” “bottom,” “front,” “back,” “over,” “above,” “under,” “below,” and such, may be used in this disclosure. These terms should not be construed as limiting the position or orientation of a structure or element but should be used to provide spatial relationship between structures or elements.

The term “semiconductor die” is used herein. A semiconductor device can be a discrete semiconductor device such as a bipolar transistor, a few discrete devices such as a pair of power FET switches fabricated together on a single semiconductor die, or a semiconductor die can be an integrated circuit with multiple semiconductor devices such as the multiple capacitors in an A/D converter. The semiconductor device can include passive devices such as resistors, inductors, filters, sensors, or active devices such as transistors. The semiconductor device can be an integrated circuit with hundreds or thousands of transistors coupled to form a functional circuit, for example a microprocessor or memory device. The semiconductor device may also be referred to herein as a semiconductor device or an integrated circuit (IC) die.

The term “semiconductor package” is used herein. A semiconductor package has at least one semiconductor die electrically coupled to terminals and has a package body that protects and covers the semiconductor die. In some arrangements, multiple semiconductor dies can be packaged together. For example, a power metal oxide semiconductor (MOS) field effect transistor (FET) semiconductor device and a second semiconductor device (such as a gate driver die, or a controller die) can be packaged together to from a single packaged electronic device. Additional components such as passive components, such as capacitors, resistors, and inductors or coils, can be included in the packaged electronic device. The semiconductor die is mounted with a package substrate that provides conductive leads. A portion of the conductive leads form the terminals for the packaged device. In wire bonded integrated circuit packages, bond wires couple conductive leads of a package substrate to bond pads on the semiconductor die. The semiconductor die can be mounted to the package substrate with a device side surface facing away from the substrate and a backside surface facing and mounted to a die pad of the package substrate. The semiconductor package can have a package body formed by a thermoset epoxy resin mold compound in a molding process, or by the use of epoxy, plastics, or resins that are liquid at room temperature and are subsequently cured. The package body may provide a hermetic package for the packaged device. The package body may be formed in a mold using an encapsulation process, however, a portion of the leads of the package substrate are not covered during encapsulation, these exposed lead portions form the terminals for the semiconductor package. The semiconductor package may also be referred to as a “integrated circuit package,” a “microelectronic device package,” or a “semiconductor device package.”

While various examples of the present disclosure have been described above, it should be understood that they have been presented by way of example only and not limitation. Numerous changes to the disclosed examples can be made in accordance with the disclosure herein without departing from the spirit or scope of the disclosure. Modifications are possible in the described embodiments, and other embodiments are possible, within the scope of the claims. Thus, the breadth and scope of the present invention should not be limited by any of the examples described above. Rather, the scope of the disclosure should be defined in accordance with the following claims and their equivalents.

What is claimed is:

1. A method comprising:
receiving first input from a first processor core, wherein the first input is written by the first processor core to a first set of registers;
receiving second input from a second processor core, wherein the second input is written by the second processor core to a second set of registers;
arbitrating between the first set of registers and the second set of registers to access a buffer, including writing the first input from the first set of registers into the buffer and then subsequently writing the second input from the second set of registers into the buffer; and
performing a first transaction according to the first input, wherein the first transaction is performed on a data memory, the first transaction including writing first feedback data to the first set of registers.

2. The method of claim 1, further comprising:
performing a second transaction according to the second input, wherein the second transaction is performed on the data memory subsequent to performing the first transaction, the second transaction including writing second feedback data to the second set of registers.

3. The method of claim 1, wherein the first transaction includes writing to a queue data structure in the data memory.

4. The method of claim 1, wherein the first transaction includes reading from a queue data structure in the data memory.

5. The method of claim 1, wherein the first transaction includes a push operation for a queue data structure in the data memory, including:
reading a header of the queue data structure to determine a write pointer;
writing to the queue data structure according to the write pointer; and
updating the write pointer based on writing to the queue data structure.

6. The method of claim 5, wherein the first feedback data includes a completion status for the push operation.

7. The method of claim 1, wherein the first transaction includes a pop operation for a queue data structure in the data memory, including:
reading a header of the queue data structure to determine a read pointer;
reading from the queue data structure according to the read pointer, including popping read data from the queue data structure; and
updating the read pointer based on reading from the queue data structure.

8. The method of claim 7, wherein the first feedback data includes the read data.

9. The method of claim 1, wherein the first transaction includes a peek operation for a queue data structure in the data memory, including:
reading from the queue data structure; and
not updating a read pointer based on the peek operation.

10. The method of claim 1, wherein the first transaction includes a push operation for an ordered queue data structure in the data memory, including:
reading a header of the ordered queue data structure to determine a write pointer and read pointer;
writing to the ordered queue data structure according to the write pointer, including performing a linear key search within the ordered queue data structure and inserting write data within the ordered queue data structure according to the linear key search; and
updating the write pointer or read pointer based on writing to the ordered queue data structure.

11. The method of claim 1, wherein performing the first transaction includes reading a pointer to an address in a data memory, wherein the pointer is included in the first input.

12. The method of claim 11, wherein performing the first transaction includes:
reading a header of a queue data structure at the address in the data memory;
determining, from reading the header, whether the queue data structure comprises an ordered queue data structure; and
performing the first transaction according to whether the queue data structure comprises an ordered queue data structure.

13. The method of claim 11, wherein performing the first transaction includes:
reading a header of a queue data structure at the address in the data memory;
determining, from reading the header, a size of the queue data structure; and
performing a push, a pop, or a peek operation on the queue data structure according to the size of the queue data structure and either a read pointer or a write pointer in the header.

14. A network accelerator comprising:
a first processor core; a second processor core;
a queue manager having a first set of registers corresponding to an identification of the first processor core and a second set of registers corresponding to an identification of the second processor core; and
a data memory configured to store a plurality of queue data structures;
wherein the queue manager is configured to:
receive input data from the first processor core and the second processor core into the first set of registers and the second set of registers, respectively;
write the input data from the first set of registers and the second set of registers into a buffer, including arbitrating between the first set of registers and the second set of registers;
read the contents from the buffer into a state machine; and
perform operations on the plurality of queue data structures according to the state machine.

15. The network accelerator of claim 14, wherein the first set of registers is memory mapped to the first processor core, and wherein the second set of registers is memory mapped to the second processor core.

16. The network accelerator of claim 14, wherein the queue manager is further configured, as part of the state machine, to:
read a first header of a first queue data structure of the plurality of queue data structures, including reading an indication of whether the first queue data structure is an ordered queue data structure.

17. The network accelerator of claim 14, wherein the queue manager is further configured, as part of the state machine, to:
read a first header of a first queue data structure of the plurality of queue data structures, including reading a read pointer and a write pointer of the first queue data structure and reading a size of the first queue data structure.

18. A circuit device comprising:
a first plurality of registers that is memory mapped to a first processor core;
a second plurality of registers that is memory mapped to a second processor core; and
hardware logic configured to:
arbitrate between the first plurality of registers and the second plurality of registers for writing from the first plurality of registers and the second plurality of registers to a first in first out (FIFO) buffer;
read contents from the FIFO buffer;
perform push operations and pop operations on a plurality of queue data structures; and
return feedback data to the first plurality of registers and to the second plurality of registers.

19. The circuit device of claim 18, wherein the hardware logic is configured to read a header of a first queue data structure of the plurality of queue data structures to determine whether the first queue data structure is an ordered queue data structure.

20. The circuit device of claim 18, wherein the hardware logic is configured to: write completion results of the push operations and the pop operations as the feedback data.
